(19) United States
(12) Patent Application Publication
(10) Pub. No.: US 2024/0372414 A1
(43) Pub. Date: Nov. 7, 2024

(54) METHOD FOR ENERGY MANAGEMENT OF A BATTERY-POWERED WIRELESS NODE AND A WIRELESS NODE

(71) Applicant: Diehl Metering Systems GmbH, Nürnberg (DE)

(72) Inventors: Petra Joppich-Dohlus, Rathsberg (DE); Achim Schmidt, Weissenohe (DE); Dominik Elberskirch, Nürnberg (DE); Karolin Weiss, Nürnberg (DE)

(21) Appl. No.: 18/633,659

(22) Filed: Apr. 12, 2024

(30) Foreign Application Priority Data
May 4, 2023 (DE) 10 2023 111 683.5

(51) Int. Cl. H02J 50/80; H02J 50/12

(52) U.S. Cl. CPC H02J 50/80; H02J 50/12

(57) ABSTRACT

A method for energy management of a battery-powered wireless node for bidirectional data transmission in a long range wide area network (LoRaWAN) between the wireless node and a network server and/or an application server via at least one gateway. The wireless node goes into a transmit mode for an uplink transmission, and into a receive mode for receiving a downlink. The wireless node opens at least one receive window after an uplink transmission. On a basis of a credit point system during operation of the wireless node, a current sending or not-sending of an uplink transmission and/or a current processing or not-processing of a, preferably received, downlink transmission is controlled according to a credit point score of the credit point system of the wireless node.

### CROSS-REFERENCE TO RELATED APPLICATION

This application is a continuation-in-part of German Patent Application DE 10 2023 111 683.5, filed May 4, 2023, the prior application is herewith incorporated by reference in its entirety.

### FIELD AND BACKGROUND OF THE INVENTION

The present invention relates to a method for energy management of a battery-powered wireless node for bidirectional data transmission in a long range wide area network between the wireless node and a network server and/or an application server via at least one gateway, and to a wireless node containing an antenna, a control unit, a battery and a sensor device and/or an actuator device.

The invention relates to a method for energy management of a battery-powered wireless node in a Long Range Wide Area Network (LoRaWAN) as described in the LoRaWAN L2 1.0.4 specification (TS001-1.0.4), for example. This is a wireless network that uses unlicensed frequency bands. A large number of wireless nodes are provided in such a network, each communicating by radio with at least one gateway by means of bidirectional data transmission. The gateway forwards the data received from the wireless nodes to a network server, which in turn forwards the data to an application server, and vice versa. In the bidirectional data transmission, messages are sent in an uplink transmission from the wireless node to the network server or the application server, and are sent in the downlink from the application server or the network server to the wireless node.

A wireless node can be a sensor device for capturing data of any type, an actuator device for performing certain actions or measures, or a combination of a sensor device and an actuator device. Such wireless nodes are powered by their own, i.e. self-sufficient, energy supply in the form of a battery, preferably a long-life battery, which has a limited operating life depending on the specific energy consumption of the wireless node and is not rechargeable. Normally, a service life “in the field” of at least ten years can be achieved with such a battery until it needs replacing.

In accordance with the LoRaWAN specification, a wireless node opens at least one receive window after every uplink transmission in order to receive a downlink transmission from the network server or the application server. In this case, first a receive window is opened a specified time after the uplink transmission and then remains open for a certain time. If no datagrams or commands are received from the gateway in this receive window, the wireless node opens a second receive window. The second receive window is likewise opened at a specified time after the uplink transmission and remains open for a certain time. The wireless node can also open further receive windows, for example, independently of an uplink transmission. Alternatively, after the uplink transmission, the wireless node can open a receive window that remains permanently open until the next uplink transmission.

The wireless node needs energy for sending uplink transmissions and receiving and processing downlink transmissions, which is provided by the battery. The wireless node cannot influence or control the receiving and processing of datagrams or commands in a downlink transmission. Therefore, the wireless node has no influence on the energy consumption when receiving or processing a downlink transmission. Consequently, under certain circumstances, the wireless node consumes too much energy when receiving and processing datagrams or commands, with the result that the battery is exhausted prematurely, and the wireless node does not achieve the intended service life of ten years.

### SUMMARY OF THE INVENTION

The object of the present invention is to provide a method for operating a battery-powered wireless node in a Long Range Wide Area Network (LoRaWAN), which method can be used to control the energy consumption of the wireless node.

### Achieving the Object

The above object is achieved by a method having the features of the independent method claim and by a wireless node according to the independent wireless node claim. The associated dependent claims contain expedient embodiments of the method according to the invention and of the wireless node.

According to the invention, a method is provided for energy management of a battery-powered wireless node for bidirectional data transmission in a Long Range Wide Area Network (LoRaWAN) between the wireless node and a network server and/or an application server via at least one gateway. The wireless node goes into a transmit mode for an uplink transmission, and into a receive mode for receiving a downlink. The wireless node opens at least one receive window after an uplink transmission, and wherein, on the basis of a credit point system during operation of the wireless node, a current sending or not-sending of an uplink transmission and/or a current processing or not-processing of a, preferably received, downlink transmission is controlled according to a credit point score of the credit point system of the wireless node.

The credit point score represents a number of credit points and reflects the energy available to the wireless node at that instant for bidirectional data transmission. In this context, a credit point, or the credit point score, equates to, for instance, a certain amount of power, energy, current or voltage. The uplink transmission and/or the processing of the, preferably received, downlink transmission can be influenced on the basis of the available energy. The power consumption or energy consumption of the wireless node can be limited effectively by the control of the uplink transmission and/or processing of the downlink transmission by the wireless node. It is thus possible, for instance when there is a low credit point score, to influence the uplink transmission and/or processing of the downlink transmission. These measures can reduce the energy consumption of the wireless node effectively. This can hence ensure that the wireless node has a sufficient service life. The receive windows are expediently opened according to a sent uplink transmission.

Expediently, in particular during operation of the wireless node using the credit point system, the credit point score of the wireless node is increased, preferably progressively, for each elapsed unit of time by a predetermined number of credit points, for instance by incrementing or addition. The unit of time is, for example, seconds, minutes, hours or days. The energy currently available to the wireless node for bidirectional data transmission is thereby increased per unit of time.

Expediently, as a result of implementation of an uplink transmission performed by the wireless node and/or of the processing of a downlink transmission, the, preferably current, credit point score of the wireless node is reduced, for instance by decrementing or subtraction, in particular by a predetermined number of credit points. This reduces according to the transmit activity and/or processing activity carried out, the energy currently available to the wireless node for bidirectional data transmission. Expediently, the credit point score is reduced before the uplink transmission, for instance by the number of credit points predetermined for the bidirectional data transmission, in particular for the processing of a downlink transmission and for the uplink transmission.

In particular, the credit point score is thereby variable and dependent on the radio activity of the wireless node. When there is high radio activity, i.e. a large number of uplink transmissions and/or processings of downlink transmissions, the credit point score drops, whereas it remains the same or rises when there is little or no radio activity by the wireless node. In particular, the predetermined number of credit points by which the credit point score is increased, and/or the predetermined number of credit points by which the credit point score is reduced, is a whole number.

The uplink transmission by the wireless node expediently involves sending a datagram or a request or a part of a datagram or a part of a request or a warning message or a response or a part of a response. For example, a request can involve the wireless node asking the network server for time synchronization. A response involves in particular a reply by the wireless node to a downlink transmission. The warning message is expediently sent when a certain credit point score is reached.

The processing involves in particular the wireless node administering or data-processing a datagram or a command or a part of a datagram or a part of a command of a received downlink transmission.

Advantageously, in the credit point system, a predetermined number of credit points is allocated to a certain type of datagram or command or a certain part of a datagram or part of a command. Each type of bidirectional data transmission, i.e. each type of uplink transmission and each type of downlink transmission, can thereby be allocated a number of credit points, which in particular equates to the energy required for the transmission and, for example, the data processing of the downlink transmission. The datagrams or commands, or a part of either, can involve, for example, firmware updates, frequency harmonizations and/or time harmonizations between the wireless node and the network server and/or the application server.

Alternatively, in the credit point system, a predetermined number of credit points can be allocated according to the size, for instance in bits, of the uplink transmission and/or of the downlink transmission. The wireless node knows from the size of the uplink or downlink transmission, the time it needs to send the uplink transmission or to receive the downlink transmission. Based on the time and the energy per unit of time needed for the sending or the receiving, the wireless node ascertains the total energy required for the uplink transmission and/or for receiving the downlink transmission, and hence also the number of credit points needed for this. The credit points required can hence be determined extremely accurately.

The credit point system is expediently controlled by a control unit of the wireless node. The wireless node can thereby control the method, in particular autonomously. The method can hence be controlled independently of the gateway and/or the network server and/or the application server.

The credit point score of the wireless node is expediently transferred to the network server and/or the application server. This transmission can be implemented as part of a routine transmission, or when a certain credit point score is reached, for instance as a warning message. The network server and/or the application server are thereby informed of the current credit point score of the wireless node. For this purpose, the wireless node transfers its current credit point score preferably with every uplink transmission or at certain intervals.

The possibility of transferring the credit point score and/or the warning message to the network server and/or the application server in an uplink transmission, in particular in an uplink transmission containing payload or wanted data, means that the notification of the credit point score can be transmitted to the network server and/or the application server in conjunction with an uplink transmission taking place as usual or as standard, for instance a meter-reading notification. A separate or specific uplink transmission for the credit point score can thus be omitted. Alternatively, the credit point score and/or the warning message can be transmitted in a dedicated uplink transmission.

The following measures for reducing the energy consumption can be taken expediently according to the credit point score of the wireless node:
the network server and/or the application server do not send a downlink transmission to the wireless node; and/or
the wireless node does not process a received downlink transmission; and/or
the wireless node does not send a response to a received downlink transmission; and/or
the wireless node does not send an uplink transmission currently due to be sent.

By the network server and/or the application server not sending a downlink transmission to the wireless node according to the credit point score, the wireless node does not receive, and also does not have to administer or process, a downlink transmission. This can reduce the energy consumption of the wireless node.

As a result of the wireless node not administering or processing, according to the credit point score, a downlink transmission currently being received, then although the wireless node needs energy to receive the downlink transmission, no energy is needed to administer or process the downlink transmission. The wireless node can thereby save energy, even if the wireless node receives datagrams or commands sent in a downlink transmission by the network server and/or the application server.

By the wireless node not sending, according to the credit point score, a response to a downlink transmission currently being received, the wireless node can save energy.

Energy is saved as a result of the wireless node not sending a current uplink transmission according to the credit point score. In particular, the wireless node hence does not open any receive windows that are dependent on the uplink transmission. In addition, the network server and/or the application server do not send a downlink transmission in response to the uplink transmission. This saves a particularly large amount of energy on the part of the wireless node.

Preferably at least one of the measures for reducing the energy consumption is taken when a first limit value is reached or dropped below. In particular, a certain credit point score is assigned to the first limit value. Thus, for instance, certain energy-saving measures can be carried out when the first limit value is dropped below, allowing a reduction in the energy consumption of the wireless node. Expediently, when the first limit value is reached or dropped below, the following measures are taken, for example:
the network server and/or the application server do not send a downlink transmission to the wireless node; and/or
the wireless node does not process a received downlink transmission; and/or
the wireless node does not send a response to a received downlink transmission.

In particular, when the first limit value is reached or dropped below, the wireless node can transfer a notification, for instance an alert or a warning message, to the network server and/or the application server to notify the one and/or the other of a drop below the first limit value. For example, the notification can be performed here as an uplink transmission or as a direct response to a downlink transmission.

Advantageously, at least one of the measures for reducing the energy consumption is taken when a second limit value is reached or dropped below, where a lower credit point score is assigned to the second limit value compared with the first limit value. When the second limit value is dropped below, the wireless node can implement an additional energy-saving measure, for instance by the wireless node not sending an uplink transmission that is currently due to be sent.

Expediently, the at least one receive window is opened at a certain time interval after the end of the uplink transmission, thereby providing the network server and/or the application server with enough time for a downlink transmission, for instance in response to the uplink transmission. For example, the time interval for a first receive window equals between 1 s and 15 s from the end of the uplink transmission.

In particular, a first and a second receive window are provided, with the second receive window being opened if a downlink transmission is not received in the first receive window. This creates additional energy-saving potential because the second receive window is opened only when a downlink transmission is not received in the first receive window. If a downlink transmission is received in the first receive window, the second receive window is accordingly not opened. Expediently, the second receive window is opened between 2 s and 16 s after the end of the uplink transmission. In particular, the first receive window and the second receive window are not open at the same time but offset from each other.

Advantageously, the second receive window is opened at a time offset from the first receive window.

Alternatively or additionally, further or third receive windows can be provided, which are opened periodically, i.e. successively, at predetermined time intervals. This creates additional opportunities for a downlink transmission that are independent of an uplink transmission.

Expediently, the wireless node goes from a sleep mode or idle mode into a transmit mode for an uplink transmission, and from a sleep mode or idle mode into a receive mode for receiving a downlink. In sleep mode or idle mode, in particular only the radio activity of the wireless node is in shutdown or is switched-off, whereas other activities such as sensor activities and/or actuator activities are still guaranteed.

Preferably, the wireless node goes into sleep mode or idle mode after the uplink transmission and/or after the closure of the first receive window and/or of the second receive window and/or of the third receive windows. This is a simple way to save energy.

According to the invention, the wireless node contains an antenna, a control unit, a battery and a sensor device and/or an actuator device, wherein the wireless node is designed to perform the method according to any of the method claims. Expediently, the wireless node is a sensor device, in particular a consumption meter for measuring electricity consumption or gas consumption or water consumption. Alternatively, the wireless node can be an actuator device for performing certain actions or measures, or a combination of a sensor device and an actuator device.

Expediently, the wireless node is not continuously in a transmit mode and/or a receive mode. In particular, the wireless node can be a bidirectional LoRaWAN end device of class A or class B, for instance as given by the LoRaWAN L2 1.0.4 specification (TS001-1.0.4).

The gateway is, for example, a device that merely forwards the uplink and downlink transmissions. Alternatively or additionally, the gateway can be in the form of a concentrator or router or access point or base station.

At the application server can be stored, in particular, measured consumption values from the wireless node. A utility company, for instance, can access these measured consumption values, and, for example, evaluate the measured consumption values and bill the consumption on the basis thereof.

The wireless node can expediently be operated in the unlicensed ISM bands or SRD bands, preferably in a frequency band in the range of 865.0-868.0 MHz or 868.0-868.6 MHz or 869.4-869.65 MHz or 902-928 MHz.

Other features which are considered as characteristic for the invention are set forth in the appended claims.

Although the invention is illustrated and described herein as embodied in a method for energy management of a battery-powered wireless node and a wireless node, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a long range wide area network (LoRaWAN);

FIG. 2 is a block diagram of an example wireless node for bidirectional data transmission with a network server and/or an application server via a gateway;

FIG. 3 is a highly simplified representation of a receive window opened by the wireless node shown in FIG. 2 according to a first embodiment;

FIG. 4 is a highly simplified representation of the receive window opened by the wireless node shown in FIG. 2 according to a second embodiment;

FIG. 5 is a graph showing an example of a variation over time of a credit point score of the wireless node shown in FIG. 2;

FIG. 6A is a block diagram of a bidirectional data transmission between the wireless node, the network server and the application server shown in FIG. 2;

FIG. 6B is a flow diagram showing method steps for the bidirectional data transmission of FIG. 6A;

FIG. 7A is a block diagram showing by way of example a method according to the invention in the bidirectional data transmission between the wireless node, the network server and the application server shown in FIG. 6A according to a first exemplary embodiment;

FIG. 7B is a graph showing method steps of the bidirectional data transmission of FIG. 7A according to the invention;

FIG. 8A is a block diagram showing by way of example of the method according to the invention in the bidirectional data transmission between the wireless node, the network server and the application server of FIG. 6A according to a second exemplary embodiment;

FIG. 8B is a flow diagram showing method steps of the bidirectional data transmission of FIG. 8A according to the invention; and

FIG. 9 is a block diagram showing a highly simplified representation by way of example of the method according to the invention in the bidirectional data transmission between the wireless node, the network server and the application server of FIG. 6A according to a third exemplary embodiment.

### DETAILED DESCRIPTION OF THE INVENTION

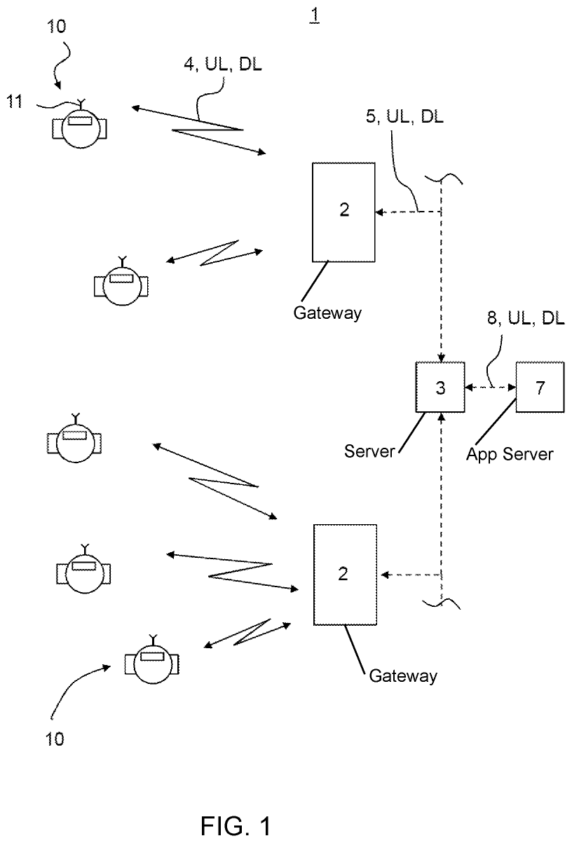

Referring now to the figures of the drawings in detail and first, particularly to FIG. 1 thereof, there is shown a highly simplified schematic representation of a Long Range Wide Area Network (LoRaWAN) 1. The LoRaWAN 1 shown contains a plurality of wireless nodes 10 having an antenna 11, and contains a network server 3, an application server 7 and two gateways 2. The wireless nodes 10 communicate with the gateways 2 by means of radio-based data transmission 4. In particular, a wireless node 10 communicates only with one gateway 2. This is illustrated in FIG. 1. Here, the top two wireless nodes 10 communicate with the top gateway 2, and the bottom three wireless nodes 10 communicate with the bottom gateway 2. The gateways 2 communicate with the network server 3 by means of radio-based or cable-based data transmission 5. The network server 3 also communicates with the application server 7 by means of data transmission 8. Alternatively, just one gateway 2 or more than two gateways 2 can be provided in the LoRaWAN 1.

Bidirectional data transmission takes place between an individual wireless node 10 and the network server 3 and/or the application server 7 via the gateway 2 in communication with the individual wireless node 10. For bidirectional data transmission between the individual wireless nodes 10 and the application server 7, this takes place additionally via the network server 3. In this process, an uplink transmission UL is transmitted from the wireless node 10 to the gateway 2 by means of the radio-based data transmission 4, and from there to the network server 3 by means of the radio-based or cable-based data transmission 5. This server transmits the uplink transmission onwards to the application server 4. A downlink transmission DL is transmitted from the application server 4 or the network server 3 to the gateway 2 by means of the data transmission 5, and from there to the wireless node 10 by means of the data transmission 4. Alternatively, the bidirectional data transmission between the wireless node 10 and the network server 3 can also take place via a plurality of gateways 2 (not shown in the figures).

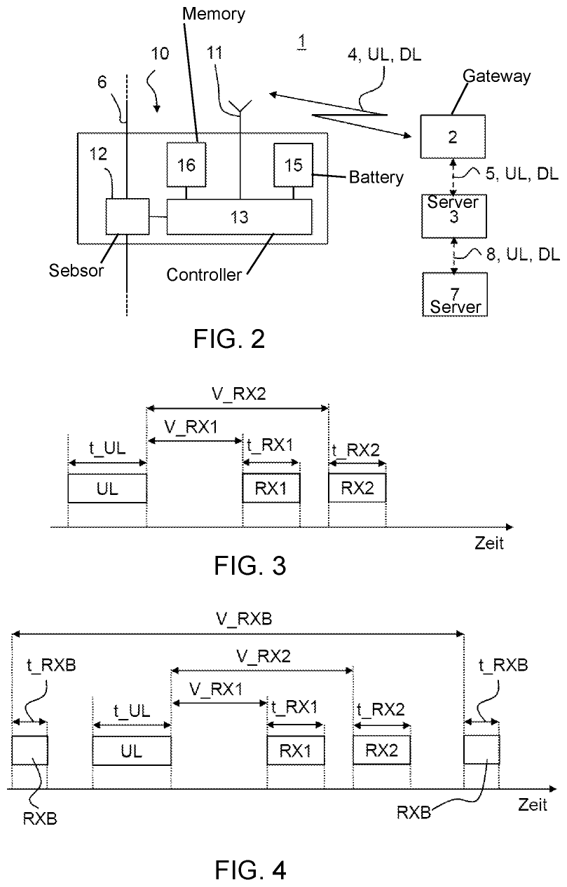

The wireless node 10 is supplied with energy via a battery 15 (see FIG. 2). The battery 15 can be a long-life battery, for instance. Normally, a service life “in the field” of at least ten years can be achieved with such a long-life battery.

The wireless node 10 also comprises a control unit 13 and a memory 16. The wireless node 10 shown in FIG. 2 is a sensor device for capturing data of any type. The wireless node 10 contains for this purpose a sensor 12, mounted on a supply line 6, for instance for capturing an electricity consumption or a flow rate of a liquid or gas. Alternatively, the wireless node 10 can also be an actuator device for performing certain actions or measures, or a combination of a sensor device and an actuator device.

The readings measured by the sensor 12 are transmitted to the control unit 13. For example, the control unit 13 processes the readings and then saves these in the memory 16. Alternatively, the readings can be saved in the memory 16 directly, i.e. without any processing by the control unit 13. The control unit 13 can access the, for instance processed, readings stored in the memory 16, and send these, for instance as a datagram, via the antenna 11 to the application server 4 via the gateway 2 and the network server 3 by means of an uplink transmission UL.

Before the uplink transmission UL, the wireless node 10 is in a sleep mode or idle mode, for example, in which the radio activity of the wireless node 10 is in shutdown or is switched-off. The capture of consumption data by the sensor 12 remains guaranteed, however. For the uplink transmission UL, the wireless node 10 shifts from sleep mode into a transmit mode. As shown in FIG. 3, the uplink transmission UL needs a certain transmission time length t_UL until the uplink transmission UL is completed. After the uplink transmission UL, the wireless node 10 preferably shifts back into sleep mode.

After a certain time interval V_RX1 has elapsed after the uplink transmission UL, the wireless node 10 shifts from sleep mode into a receive mode and opens a first receive window RX1. The time interval V_RX1 is calculated from the end of the uplink transmission UL and, for example, is a time value between 1 s and 15 s. The first receive window RX1 is open for a certain time length t_RX1, which the wireless node 10 needs to receive a downlink transmission DL. The first receive window RX1 is closed again as soon as the time length t_RX1 has elapsed. The wireless node 10 now preferably shifts from receive mode back into sleep mode.

In the event that the wireless node 10 has not received a downlink transmission DL during the first receive window RX1, the wireless node 10 opens a second receive window RX2, which is opened at a certain time interval V_RX2, for instance a time value between 2 s and 16 s, after the completion of the uplink transmission UL. The second receive window RX2 is thus offset in time from the first receive window RX1. The wireless node 10 shifts for this from sleep mode into receive mode. The second receive window RX2 is likewise open for a certain time length t_RX2, which the wireless node 10 needs to receive a downlink transmission DL. After the timespan t_RX2 has elapsed, the second receive window RX2 is closed again, and the wireless node 10 preferably shifts back into sleep mode.

The wireless node 10 can open further, or third, receive windows RXB in addition to the receive windows RX1 and RX2, as shown in FIG. 4. In order to open the receive window RXB, the wireless node 10 shifts from sleep mode into receive mode. The receive window RXB is open for a certain time length t_RXB, which the wireless node 10 needs to receive a downlink transmission DL. After the timespan t_RXB has elapsed, the receive window RXB is closed again, and the wireless node 10 preferably shifts back into sleep mode. The receive windows RXB are opened at certain time intervals V_RXB, in particular independently of an uplink transmission UL. This means that a new receive window RXB is opened periodically, i.e. successively after the time interval V_RXB has elapsed.

The receive windows RX1, RX2 and RXB can remain open for the same length of time or different lengths of time. Thus the time lengths t_RX1, t_RX2 and t_RXB can be the same or different.

For each uplink transmission UL and each processing of a received downlink transmission DL, the wireless node 10 needs energy, which it is supplied by the battery 15. The wireless node 10 can influence to some extent the uplink transmission UL and hence save energy. This is not possible for the downlink transmissions DL, however, because the wireless node always receives the downlink transmissions DL from the network server 3 and/or the application server 7. During the processing of the received downlink transmission UL, the wireless node 10 uses data processing to administer or process the relevant datagrams or the part of the datagram or the relevant command or the part of the command, whereby energy is consumed. Since the wireless node 10 cannot influence the downlink transmission DL, the situation can arise in which the receiving of downlink transmissions DL and the subsequent processing consume too much energy, with the result that the capacity of the battery 16 is exhausted prematurely, and the intended service life of ten years is not achieved.

According to the method according to the invention, a credit point system is used during operation of the wireless node 10 to influence the energy consumption of the wireless node 10, thereby reducing the energy consumption effectively. The credit point system contains a credit point score N, which reflects the energy or current or voltage of the wireless node 10 currently available for a bidirectional radio transmission. Thus the credit point score N states how much energy is available to the wireless node 10 at that instant for a bidirectional radio transmission, i.e. for an uplink transmission UL and the processing of a downlink transmission DL, or how much energy the wireless node can consume at that instant. According to the invention, the sending or not-sending of an uplink transmission UL and/or a current processing or not-processing of a received downlink transmission DL is controlled according to the credit point score N.

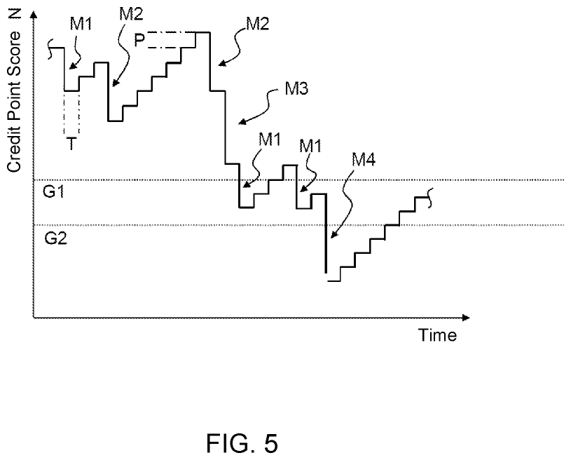

The credit point score N comprises a certain number of credit points, which changes progressively, as shown in FIG. 5. A credit point equates to a certain energy requirement. In particular, a credit point can be a certain amount of energy or current or voltage. Expediently, a credit point is a whole number. The credit point score N of the wireless node 10 is expediently transferred to the network server 3 and/or the application server 7, for instance in every uplink transmission UL.

As shown in FIG. 5, the credit point score N is increased for each unit of time T by a predetermined number of credit points P. The predetermined number of credit points P is in particular greater than or equal to 1. In particular, the predetermined number of credit points P is added onto the current credit point score N. Hence the energy available to the wireless node 10 at that instant for bidirectional data transmission increases over time. The unit of time T is a certain number of seconds, minutes, hours or days.

The credit point score N of the wireless node 10 is reduced by a predetermined number of credit points M1-M4 (see FIG. 5) when an uplink transmission UL is sent and/or when data processing activities are performed for the received downlink transmission. Each type of bidirectional data transmission, i.e. each type of uplink transmission UL and of downlink transmission DL, is allocated a predetermined number of credit points M1-M4 according to the energy required for the transmission and/or the processing. A predetermined number of credit points M1-M4 is also allocated to the receiving of the downlink transmission.

Alternatively, the wireless node 10 can determine the required energy consumption on the basis of the size of the uplink transmission UL or of the downlink transmission DL. The wireless node 10 does this by ascertaining or estimating the size of the relevant transmission. On the basis of the size of the uplink transmission UL, the wireless node 10 can determine or estimate how much time is needed for the uplink transmission UL. In addition, the wireless node 10 determines or estimates from the size of the downlink transmission DL, how much time it needs to receive said transmission. The wireless node 10 knows both the energy required per unit of time for sending an uplink transmission UL and the energy required per unit of time for receiving a downlink transmission DL. On the basis of the energy required per unit of time and the time needed for an uplink transmission UL or for receiving a downlink transmission DL, the wireless node 10 ascertains or estimates the corresponding energy requirement. The total energy required for a bidirectional data transmission is the sum of the energy required for the uplink transmission UL and the energy required for receiving the downlink transmission DL. A predetermined number of credit points M1-M4 is allocated to the bidirectional radio transmission according to the total energy required.

The credit point score N is reduced by this predetermined number of credit points M1-M4 in the event of a bidirectional data transmission. For instance, some bidirectional data transmissions need only a small amount of energy, and hence the credit point score N is reduced only by a few credit points M1. Certain bidirectional data transmissions, for instance synchronizations or changes to the transmit interval or changes to the content of an uplink transmission, need more energy, however, and therefore for these bidirectional data transmissions, the credit point score N is reduced by a larger number of credit points M4. The different grading of the number of credit points M1-M4 means that the actual energy required by a bidirectional data transmission, i.e. by an uplink transmission UL and by the processing of a downlink transmission DL, is taken into account.

FIG. 5 shows by way of example the variation over time of the credit point score N. The credit point score N is initially reduced by a number of credit points M1 because of a bidirectional data transmission. Then, the credit point score N rises again over two units of time T, with the credit point score N being increased by a certain number of credit points P per unit of time. The credit point score N is reduced again by a number of credit points M2 as a result of a further bidirectional data transmission. Then the credit point score N rises again. As a result of a plurality of further data transmissions, the credit point score N is first reduced by the number of credit points M2 and then by the number of credit points M3.

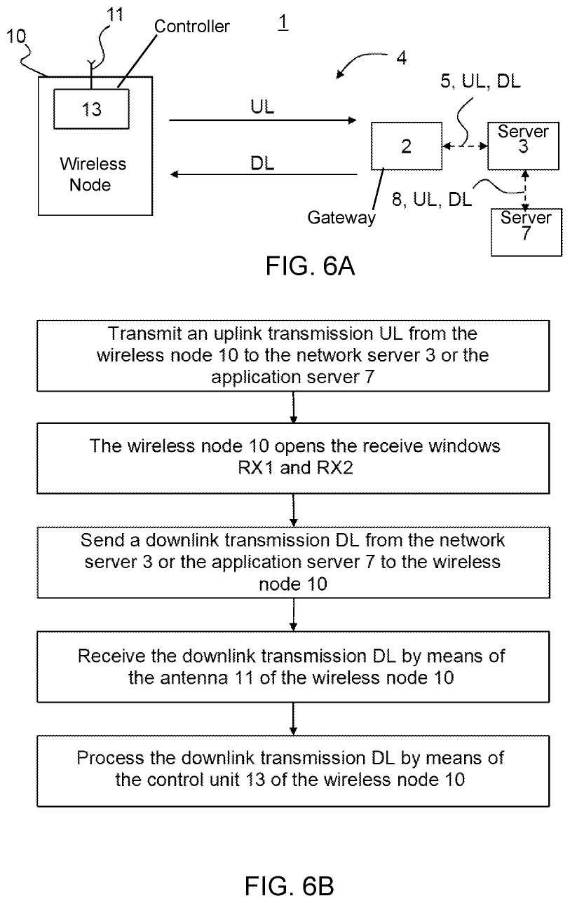

The bidirectional data transmission between the wireless node 10 and the network server 3 or the application server 7 takes place here according to the method shown in FIGS. 6A and 6B. For an uplink transmission UL, a datagram or a part of a datagram or a request or a part of a request or a warning message or a response or a part of a response is transmitted from the wireless node 10 to the network server 3 or the application server 7. The wireless node 10 subsequently opens the receive windows RX1 and RX2, as described above. The network server 3 or the application server 7, in response to the uplink transmission UL, transfers in a downlink transmission DL a datagram or a part of a datagram or a command or a part of a command to the wireless node 10, which receives the downlink transmission DL within one of the receive windows RX1 or RX2 by means of its antenna 11. This may involve in particular a response by the network server 3 or the application server 7 to the uplink transmission UL by the wireless node 10. Then the wireless node 10 processes the received downlink transmission DL by means of the control device 13. Since the network server 3 or the application server 7 sends the downlink transmission DL in response to an uplink transmission UL, it is the wireless node 10 that initiates the bidirectional data transmission DL. Expediently, the wireless node 10 thereupon sends a reply or response to the downlink transmission DL.

As a result of a bidirectional data transmission, i.e. as a result of the uplink transmission UL and the receiving of a downlink transmission DL, the credit point score N can fall below a first limit value G1 (see FIG. 5). The limit value G1 is assigned to a certain value of the credit point score N. As soon as the credit point score N falls below the first limit value G1, the wireless node 10 takes various energy-saving measures in order to reduce the energy consumption. Expediently, the network server 3 and/or the application server 7 knows the credit point score N of the wireless node 10 and thereby recognizes that the credit point score N has fallen below the first limit value G1. Alternatively or additionally, the wireless node 10 can transfer an alert signal or a particular indication to the network server 3 and/or the application server 7, informing the servers that the credit point score N lies below the first limit value G1.

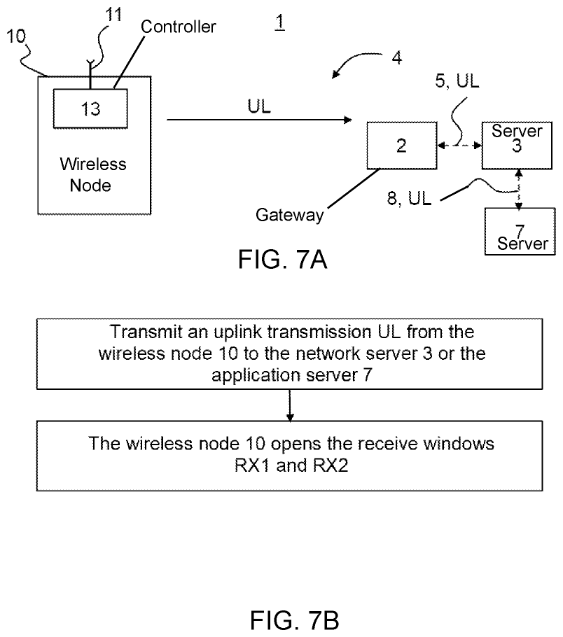

FIGS. 7A and 7B show the method according to the invention for reducing the energy consumption in the bidirectional data transmission between the wireless node 10 and the network server 3 or the application server 7 according to a first exemplary embodiment when the credit point score N has dropped below the first limit value G1, for example. Despite the energy-saving measure, the wireless node 10 continues to send an uplink transmission UL (see FIGS. 7A and 7B). In addition, the wireless node 10 opens the receive windows RX1 and RX2 after the uplink transmission UL. However, the network server 3 and/or the application server 7 know the credit point score N of the wireless node 10 or have been notified by the wireless node 10 that the credit point score N lies below the first limit value 10. As a result, the network server 3 and/or the application server 7 does not send a downlink transmission DL to the wireless node 10, or the gateway 2 does not forward this downlink transmission to the wireless node 10. Hence the wireless node 10 does not receive, and so does not have to process, a downlink transmission DL. This is an effective way for the wireless node 10 to save energy. A further reduction in the credit point score N as a result of downlink transmissions DL is consequently avoided.

Subsequently, the credit point score N can rise per unit of time T by the predetermined number of credit points P, and therefore the credit point score N can go above the first limit value G1 again. The energy-saving measure shown in FIGS. 7A and 7B is rescinded when the first limit value G1 is exceeded, and the bidirectional data transmission proceeds again in accordance with the method of FIGS. 6A and 6B.

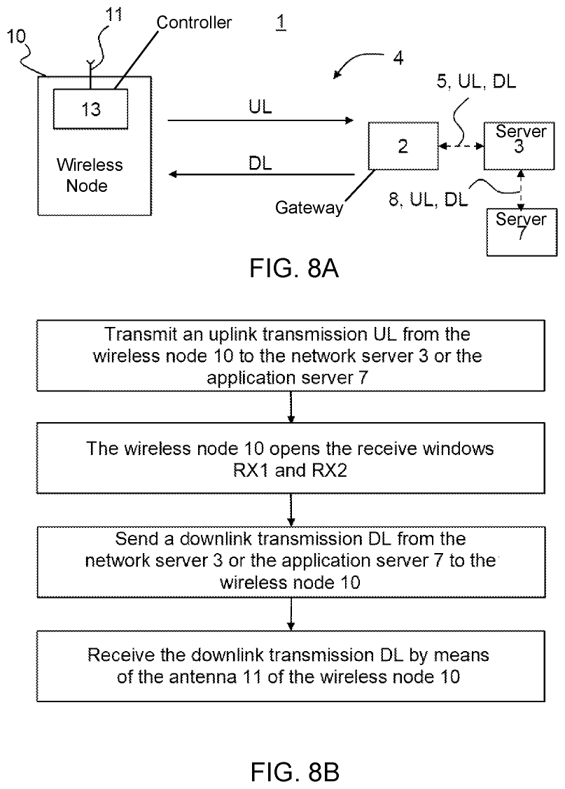

FIGS. 8A and 8B show a second exemplary embodiment of the method according to the invention for reducing the energy consumption in the bidirectional transmission between the network server 3 and/or the application server 7 and the wireless node 10. The corresponding energy-saving measure shown in FIGS. 8A and 8B can be implemented as soon as the credit point score falls below the limit value G1, for example. The energy-saving measure of the second exemplary embodiment constitutes, in particular, an alternative to the energy-saving measure of FIGS. 7A and 7B. Again in this case, the wireless node 10 sends an uplink transmission UL and then opens the receive windows RX1 and RX2. For the energy-saving measure shown in FIGS. 8A and 8B, the network server 3 and/or the application server 7 can know the credit point score N, or have been informed thereof. Nonetheless, the network server 3 and/or the application server 7 continue to send a downlink transmission DL to the wireless node 10. Since the wireless node 10 has opened the receive windows RX1 and RX2, it receives the downlink transmission DL. The control unit 13 of the wireless node 10 does not process the downlink transmission DL, however. Hence energy can be saved effectively, despite a received downlink transmission DL, because the received downlink transmission DL is not processed. Expediently, neither is a response sent to the downlink transmission DL currently being received. Hence the credit point score N subsequently rises per unit of time T by the predetermined number of credit points P until the first limit value G1 is exceeded, and the energy-saving measure shown in FIGS. 8A and 8B can be rescinded.

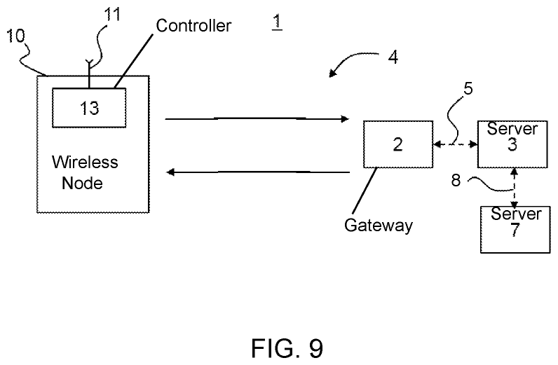

The credit point score N is expediently provided with a second limit value G2, to which is assigned a lower credit point score N compared with the first limit value G1 (see FIG. 5). If, despite the energy-saving measures shown in FIGS. 7A and 8B, the second limit value G2 is dropped below, an additional energy-saving measure is taken. This is a third exemplary embodiment of the method according to the invention for reducing the energy consumption in the bidirectional transmission between the network server 3 and/or the application server 7 and the wireless node 10, as shown in FIG. 9. According to the third exemplary embodiment, the wireless node 10 no longer sends an uplink transmission UL. As a result, the network server 3 and/or the application server 7 do not send a downlink transmission DL in response to the uplink transmission UL. Even if a downlink transmission DL were to take place, the wireless node 10 would not be able to receive it because the wireless node does not open any receive windows RX1 and RX2. Thus, the wireless node 10 stops its radio activity for the bidirectional data transmission if the credit point score N lies below the second limit value G2. It is thereby possible to save a particularly large amount of energy. Thus, the credit point score N can rise per unit of time T by the predetermined number of credit points P without any fall in the credit point score N as a result of a bidirectional data transmission. As soon as the credit point score N has exceeded the second limit value G2, the energy-saving measure shown in FIG. 9 is rescinded, and the wireless node 10 is operated using the energy-saving measures shown in FIGS. 7A and 7B, or 8A and 8B, until the credit point score N has exceeded the first limit value G1.

The control unit 13 of the wireless node 10 expediently controls the credit point system and, in particular, the method according to the invention for saving energy.

The following is a summary list of reference numerals and the corresponding structure used in the above description of the invention.

### LIST OF REFERENCES

1 LoRaWAN
2 gateway
3 network server
4 data transmission
5 data transmission
6 supply line
7 application server
8 data transmission
10 wireless node
11 antenna
12 sensor
13 control unit
15 battery
16 memory
UL uplink transmission
DL downlink transmission
G1 first limit value
G2 second limit value
RX1 receive window
RX2 receive window
RXB receive window
t_UL uplink transmission time length
t_RX1 time length
t_RX2 time length
t_RXB time length
V_RX1 time interval
V_RX2 time interval
V_RXB time interval
T unit of time
P credit points
N credit point score
M1-M4 credit points

1. A method for energy management of a battery-powered wireless node for bidirectional data transmission in a long-range wide area network between the battery-powered wireless node and a network server and/or an application server via at least one gateway, which comprises the steps of:
transitioning the battery-powered wireless node into a transmit mode for an uplink transmission, and into a receive mode for receiving a downlink, wherein the battery-powered wireless node opens at least one receive window after the uplink transmission; and
controlling a current sending or not-sending of the uplink transmission and/or a current processing or not-processing of a downlink transmission according to a credit point score of a credit point system of the battery-powered wireless node.

2. The method according to claim 1, which further comprises increasing the credit point score of the battery-powered wireless node for each elapsed unit of time by a predetermined number of credit points.

3. The method according to claim 1, wherein as a result of implementation of the uplink transmission performed by the battery-powered wireless node and/or the processing of the downlink transmission, the credit point score of the wireless node is reduced.

4. The method according to claim 1, wherein the uplink transmission involves a datagram or a part of the datagram or a request or a part of the request or a warning message or a response or a part of the response.

5. The method according to claim 1, wherein the processing involves the battery-powered wireless node administering or data-processing a received datagram or a part of the received datagram or a command or a part of the command in the downlink transmission.

6. The method according to claim 1, wherein in the credit point system, a predetermined number of credit points are allocated to a certain type of datagram or command or a part of either.

7. The method according to claim 1, wherein in the credit point system, a predetermined number of credit points are allocated according to a size of the uplink transmission and/or of the downlink transmission.

8. The method according to claim 1, which further comprises controlling the credit point system by a controller of the battery-powered wireless node.

9. The method according to claim 1, which further comprises transferring the credit point score to the network server and/or the application server.

10. The method according to claim 9, which further comprises transferring the credit point score to the network server and/or the application server in the uplink transmission.

11. The method according to claim 1, wherein following measures are taken according to the credit point score of the battery-powered wireless node:
the network server and/or the application server do not send the downlink transmission to the battery-powered wireless node; and/or
the battery-powered wireless node does not process a received downlink transmission; and/or
the battery-powered wireless node does not send a response to the received downlink transmission; and/or
the battery-powered wireless node does not send the uplink transmission currently due to be sent.

12. The method according to claim 11, which further comprises taking at least one of the measures when a first limit value is reached.

13. The method according to claim 12, wherein when the first limit value is reached, sending, via the battery-powered wireless node, a notification to the network server and/or the application server.

14. The method according to claim 12, which further comprises taking at least one of the measures when a second limit value is reached, where a lower credit point score is assigned to the second limit value compared with the first limit value.

15. The method according to claim 1, which further comprises opening the at least one receive window at a certain time interval after an end of the uplink transmission.

16. The method according to claim 1, wherein the at least one receive window includes a first receive window and a second receive window, the second receive window is opened if no datagrams or commands or a part of either are received in the first receive window.

17. The method according to claim 16, which further comprises opening the second receive window at a time offset from the first receive window.

18. The method according to claim 1, wherein further receive windows are provided, which are opened periodically at predetermined time intervals.

19. The method according to claim 1, wherein the battery-powered wireless node goes from a sleep mode into a transmit mode for the uplink transmission, and from the sleep mode into a receive mode for receiving the downlink.

20. The method according to claim 1, wherein the battery-powered wireless node goes into a sleep mode after the uplink transmission and/or after a closing of the at least one receive window.

21. A wireless node, comprising:
an antenna;
a controller;
a battery;
a sensor device and/or an actuator device; and
the wireless node is configured to implement the method according to claim 1.
